(19) United States
(12) Patent Application Publication
(10) Pub. No.: US 2013/0314451 A1
(43) Pub. Date: Nov. 28, 2013

(54) METHOD OF DRIVING A DISPLAY PANEL, DRIVING APPARATUS FOR PERFORMING THE METHOD AND DISPLAY APPARATUS INCLUDING THE DRIVING APPARATUS

(71) Applicant: SAMSUNG DISPLAY CO., LTD., Yongin-City (KR)

(72) Inventors: Jong-Hee KIM, Hwaseong-si (KR); Joo-Young KIM, Suwon-si (KR); Joon-Chul GOH, Hwaseong-si (KR); Cheol-Gon LEE, Seoul (KR); Se-Hyoung CHO, Seoul (KR); Chong-Chul CHAI, Seoul (KR)

(73) Assignee: SAMSUNG DISPLAY CO., LTD., Yongin-City (KR)

(21) Appl. No.: 13/675,605

(22) Filed: Nov. 13, 2012

(30) Foreign Application Priority Data
May 24, 2012 (KR) 10-2012-0055398

(51) Int. Cl. G09G 5/08; G09G 5/10

(52) U.S. Cl. CPC G09G 5/08; G09G 5/10
USPC 345/690; 345/209

(57) ABSTRACT

A method of driving a display panel includes receiving an input image data, based on which the display panel displays an image, outputting a first image data during N frames corresponding to a first reference time and outputting a second image data during M frames corresponding to a second reference time based on a inversion signal, where N and M are natural number, the first image data has a first polarity equal to a polarity of the input image data, and the second image data has a second polarity inverted from the polarity of the input image data, and skipping a first frame of the first image data and a first frame of the second image data based on the inversion signal.

This application claims priority to Korean Patent Application No. 10-2012-0055398, filed on May 24, 2012, and all the benefits accruing therefrom under 35 U.S.C. §119, the content of which in its entirety is herein incorporated by reference.

### BACKGROUND

1. Field

Exemplary embodiments of the invention relate to a method of driving a display panel, a driving apparatus for performing the method and a display apparatus including the driving apparatus. More particularly, exemplary embodiments of the invention relate to a method of driving a display panel in a display apparatus, a driving apparatus for performing the method and a display apparatus including the driving apparatus.

2. Description of the Related Art

Image data, polarities of which are different from each other, are typically applied to pixels adjacent to each other to effectively prevent a deterioration of a liquid crystal in a liquid crystal display apparatus.

However, when a first image data having a first polarity of the polarities is applied to a first pixel of the pixels and a second image data having a second polarity of the polarities is applied to a second pixel for a substantially long time, a direct current afterimage is displayed on a display panel including the pixels, and thus display quality of a display apparatus including the display panel may be decreased.

The polarities of the image data may be inverted per a predetermined time to effectively prevent the direct current afterimage displayed on the display panel.

However, a flicker may occur on the display panel when the polarities of the image data are inverted, and thus the display quality of the display apparatus including the display panel may be decreased.

Thus, the display quality of the display apparatus including the display panel may be improved by effectively preventing the direct current afterimage and the flicker displayed on the display panel.

### SUMMARY

Exemplary embodiments of the invention relate to a method of driving a display panel with improved display quality.

Exemplary embodiments of the invention relate to a driving apparatus for performing the above-mentioned method of driving the display panel.

Exemplary embodiments of the invention relate to provide a display apparatus having the above-mentioned driving apparatus.

According to an exemplary embodiment of the invention, a method of driving a display panel includes receiving an input image data, based on which the display panel displays an image, outputting a first image data during N frames corresponding to a first reference time and outputting a second image data during M frames corresponding to a second reference time based on a inversion signal, where N and M are natural numbers, the first image data has a first polarity equal to a polarity of the input image data, and the second image data has a second polarity inverted from the polarity of the input image data, and skipping a first frame of the first image data and a first frame of the second image data based on the inversion signal.

In an exemplary embodiment, the inversion signal may be inverted every first period, and the skipping the first frame of the first image data and the first frame of the second image data may include determining a second period, which is longer than the first period.

In an exemplary embodiment, the method may further include measuring the first reference time and the second reference time to alternately output the first image data and the second image data.

In an exemplary embodiment, the measuring the first reference time and the second reference time may include counting the number of frames.

In an exemplary embodiment, the second period may be twice longer than the first period.

In an exemplary embodiment, the image data may include a first grayscale data having a first level corresponding to a first grayscale and a second grayscale data having a second level less than the first level and corresponding to a second grayscale less than the first grayscale, the inversion signal may be inverted every first period, and the first grayscale data and the second grayscale data may be alternately disposed every first period in the image data with inverted polarities based on the inversion signal.

In an exemplary embodiment, the image data may include a first grayscale data having a first level corresponding to a first grayscale and a third grayscale data having a third level greater than the first level and corresponding to a third grayscale greater than the first grayscale, the inversion signal may be inverted every first period, and the first grayscale data and the third grayscale data may be alternately disposed in the image data every first period with inverted polarities based on the inversion signal.

In an exemplary embodiment, the inversion signal may be inverted every first period based on a vertical synchronous signal.

In an exemplary embodiment, the first period may correspond to a period of a frame.

In an exemplary embodiment, the first period may correspond to a period of two frames.

In an exemplary embodiment, the image data may correspond to data scanning method, which is converted from an interlaced scanning method to a sequential scanning method.

According to another exemplary embodiment of the invention, a driving apparatus includes a timing control part which generates an inversion signal for inverting a polarity of an input image data applied to a display panel and a data driving part, which outputs a first image data during N frames corresponding to a first reference time and a second image data during M frames corresponding to a second reference time based on an inversion signal, and skips a first frame of the first image data and a first frame of the second image data, where N and M are natural number, he first image data has a first polarity equal to the polarity of the input image data, and the second image data has a second polarity inverted from the polarity of the input image data.

In an exemplary embodiment, the inversion signal may be inverted every first period, and the data driving part may determine a second period, which is longer than the first period.

In an exemplary embodiment, the timing control part may include a timer which measures the first reference time and the second reference time.

In an exemplary embodiment, the timing control part may include a frame counter which counts the number of frames to measure the first reference time and the second reference time.

In an exemplary embodiment, the second period may be twice longer than the first period.

In an exemplary embodiment, the image data may correspond to a scanning method, which is converted from an interlaced scanning method to a sequential scanning method.

According to still another exemplary embodiment of the invention, a display apparatus includes a display panel which displays an image based on an input image data and a driving apparatus including a timing control part which generates an inversion signal inverting a polarity of the input image data applied to the display panel, and a data driving part which outputs a first image data during N frames corresponding to a first reference time and a second image data during M frames corresponding to a second reference time based on a inversion signal and skips a first frame of the first image data and a first frame of the second image data, where N and M are natural numbers, the first image data has a first polarity equal to the polarity of the input image data, and the second image data has a second polarity inverted from the polarity of the input image data.

In an exemplary embodiment, the inversion signal may be inverted every first period, and the data driving part may determine a second period, which is longer than the first period.

In an exemplary embodiment, the second period may be twice longer than the first period.

According to exemplary embodiments of the invention, a first image data and a second image data having polarities opposite to each other are alternately outputted to a data line, and thus a direct current afterimage displayed on a display panel is effectively prevented.

In exemplary embodiments, a first frame of the first image data and a first frame of the second image data are not outputted to the data line when the first image data and the second image data are outputted from a data driving part such that a flicker on the display panel is effectively prevented, and the display quality of the display apparatus is thereby substantially improved.

### BRIEF DESCRIPTION OF THE DRAWINGS

The above and other features of the invention will become more apparent by describing in detailed exemplary embodiments thereof with reference to the accompanying drawings, in which:

FIG. 1 is a block diagram illustrating an exemplary embodiment of a display apparatus according to the invention;

FIG. 2 is a block diagram illustrating an exemplary embodiment of a timing control part of FIG. 1;

FIG. 3 is a block diagram illustrating an exemplary embodiment of a data driving part of FIG. 1;

FIG. 4 is a signal timing diagram illustrating an exemplary embodiment of a first image data and a second image data outputted from the data driving part according to an inversion signal of FIG. 1;

FIG. 5 is a flow chart illustrating an exemplary embodiment of a method of driving a display panel performed by a driving apparatus of FIG. 1;

FIG. 6 is a block diagram illustrating an alternative exemplary embodiment of a timing control part according to the invention;

FIG. 7 is a flow chart illustrating an exemplary embodiment of a method of driving a display panel performed by a driving apparatus including the timing control part of FIG. 6 and the data driving part of FIG. 3;

FIG. 8 is a block diagram illustrating another alternative exemplary embodiment of a timing control part according to the invention;

FIG. 9A is a waveform diagram illustrating an exemplary embodiment of a vertical synchronous signal applied to an inversion signal generating part of FIG. 8 and an exemplary embodiment of an inversion signal outputted from the inversion signal generating part of FIG. 8; and

FIG. 9B is a waveform diagram illustrating an alternative exemplary embodiment of a vertical synchronous signal applied to the inversion signal generating part of FIG. 8 and an alternative exemplary embodiment of an inversion signal outputted from the inversion signal generating part of FIG. 8.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features.

Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

Hereinafter, exemplary embodiments of the invention will be described in detail with reference to the accompanying drawings.

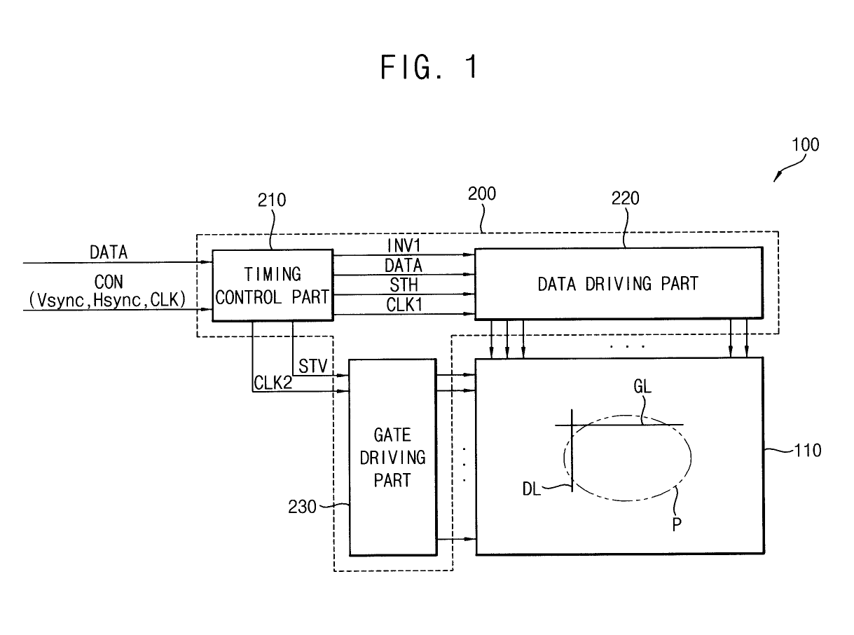

FIG. 1 is a block diagram illustrating an exemplary embodiment of a display apparatus according to the invention.

Referring to FIG. 1, an exemplary embodiment of the display apparatus 100 includes a display panel 110 and a driving apparatus 200.

The display panel 110 receives an input image data DATA to display an image. In one exemplary embodiment, for example, the input image data DATA may be corresponding to a scanning method, which is converted from an interlaced scanning method to a sequential scanning method.

The display panel 110 includes a plurality of gate lines GL, a plurality of data lines DL and a plurality of pixels P. In one exemplary embodiment, for example, the display panel 110 includes A×B numbers of pixels P, where A and B are natural numbers. Each of the pixels P includes a thin-film transistor electrically connected to a corresponding gate line of the gate lines GL and a corresponding data line of the data lines DL, a liquid crystal capacitor and a storage capacitor connected to the thin-film transistor.

The driving apparatus includes a timing control part 210, a data driving part 220 and a gate driving part 230.

The timing control part 210 receives the input image data DATA and a control signal CON from outside, e.g., from an external device. The control signal CON may include a horizontal synchronous signal Hsync, a vertical synchronous signal Vsync and a clock signal CLK, for example.

In an exemplary embodiment, the timing control part 210 generates a data start signal STH using the horizontal synchronous signal Hsync and outputs the data start signal STH to the data driving part 220. In such an embodiment, the timing control part 210 generates a gate start signal STV using the vertical synchronous signal Vsync and outputs the gate start signal STV to the gate driving part 230. In such an embodiment, the timing control part 210 generates a first clock signal CLK1 and a second clock signal CLK2, and outputs the first clock signal CLK1 to the data driving part 220 and the second clock signal CLK2 to the gate driving part 230.

In an exemplary embodiment, the timing control part 210 generates an inversion signal INV1 and outputs the inversion signal INV1 to the data driving part 220. The inversion signal INV1 may be inverted every first period, and the first period may correspond to, e.g., substantially equal to, a period of a frame. In such an embodiment, the inversion signal INV1 may maintain a level thereof during a second period, which is longer than the first period and occurs every reference time, without being inverted. In such an embodiment, the reference times may be a first reference time or a second reference time. In such an embodiment, the time interval between two adjacent second periods of the inversion signal is the first reference time or the second reference time. In one exemplary embodiment, the time interval between two adjacent second periods of the inversion signal is alternately either the first reference time or the second reference time. In one exemplary embodiment, for example, the second period may be twice longer than the first period, and the reference time may be about 15 seconds.

The data driving part 220 outputs a first image data having a first polarity equal to a polarity of the input image data DATA to the data line DL in response to the first clock signal CLK1 and the data start signal STH provided from the timing control part 210.

The data driving part 220 outputs a second image data having a second polarity inverted from the polarity of the input image data DATA to the data line DL based on the inversion signal INV1 provided from the timing control part 210.

In an exemplary embodiment, the data driving part 220 outputs the first image data having the first polarity equal to the polarity of the input image data DATA during N frames corresponding to the first reference time and outputs the second image data having the second polarity inverted from the polarity of the input image data DATA during M frames corresponding to the second reference time. Here, N and M are natural number. In such an embodiment, the data driving part 220 alternately inverts the input image data whenever the inversion signal has the second period.

In an exemplary embodiment, the data driving part 220 skips a first frame of the first image data and a first frame of the second image data based on the inversion signal INV1 provided from the timing control part 210. Thus, in such an embodiment, the data driving part 220 does not output the first frame of the first image data and the first frame of the second image data to the data line DL.

The gate driving part 230 generates a gate signal using the gate start signal STV and the second clock signal SLK2 provided from the timing control part 210 and outputs the gate signal to the gate line GL.

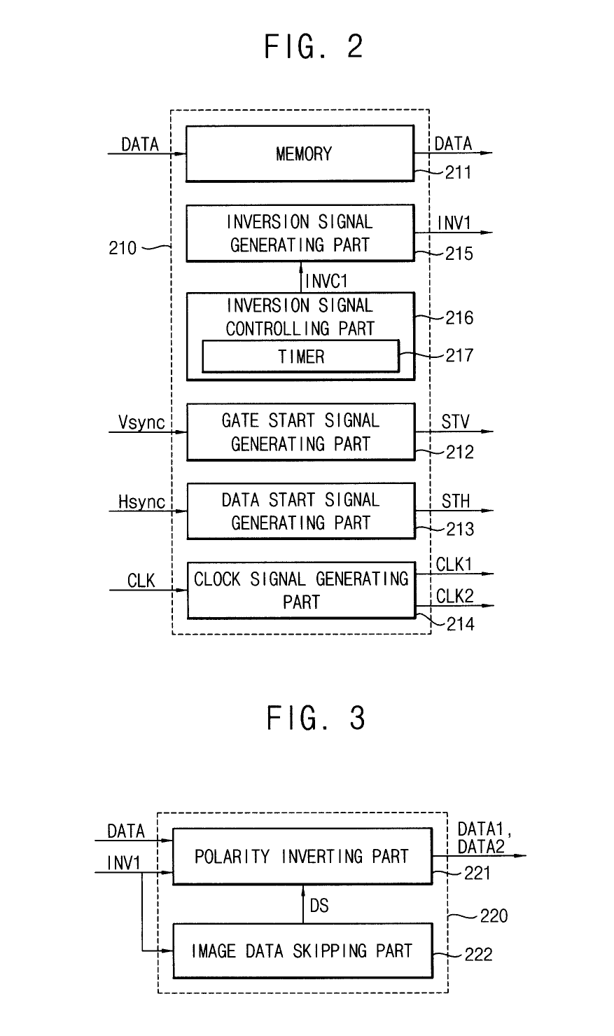

FIG. 2 is a block diagram illustrating an exemplary embodiment of the timing control part 210 of FIG. 1.

Referring to FIGS. 1 and 2, the timing control part 210 includes a memory 211, a gate start signal generating part 212, a data start signal generating part 213, a clock signal generating part 214, an inversion signal generating part 215 and an inversion signal controlling part 216.

The memory 211 receives the input image data DATA from outside and outputs the input image data DATA to the data driving part 220.

The gate start signal generating part 212 generates the gate start signal STV using the vertical synchronous signal Vsync and outputs the gate start signal STV to the gate driving part 230.

The data start signal generating part 213 generates the data start signal STH using the horizontal synchronous signal Hsync and outputs the data start signal STH to the data driving part 220.

The clock signal generating part 214 generates the first clock signal CLK1 and the second clock signal CLK2 using the clock signal CLK and outputs the first clock signal CLK1 to the data driving part 220 and the second clock signal CLK2 to the gate driving part 230.

The inversion signal generating part 215 generates the inversion signal INV1 and outputs the inversion signal INV1 to the data driving part 220. The inversion signal INV1 may be inverted every first period, and the first period may correspond to the period of the frame.

The inversion signal controlling part 216 outputs an inversion signal controlling signal INVC1 to the inversion signal generating part 215 to control the inversion signal INV1. In one exemplary embodiment, for example, the inversion signal controlling part 216 may control the inversion signal INV1 to maintain a level thereof without being inverted during the second period, which may be twice longer than the first period and occurs every reference time. The inversion signal controlling part 216 may include a timer 217 that measures the reference time, e.g., the first reference time or the second reference time. In one exemplary embodiment, for example, the inversion signal controlling part 216 may control the inversion signal INV1 such that the inversion signal INV1 has the second period every about 15 seconds.

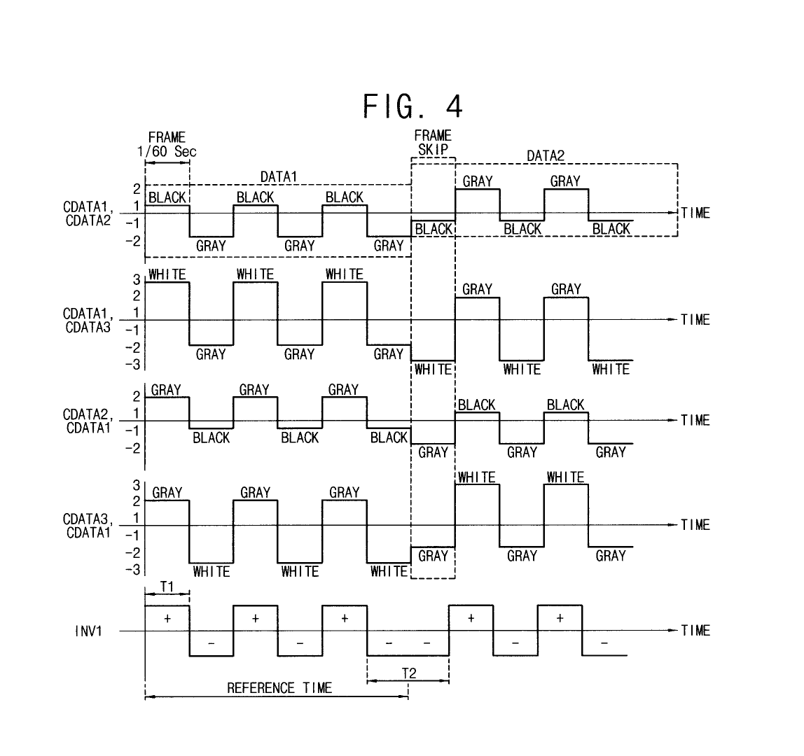

FIG. 3 is a block diagram illustrating an exemplary embodiment of the data driving part 220 of FIG. 1.

Referring to FIGS. 1 to 3, the data driving part 220 includes a polarity inverting part 221 and an image data skipping part 222.

In an exemplary embodiment, the polarity inverting part 221 outputs the first image data DATA1 having the first polarity equal to the polarity of the input image data DATA and the second image data DATA2 having the second polarity inverted from the polarity of the input image data DATA based on the inversion signal INV1 provided from the timing control part 210. In such an embodiment, the first polarity of the first image data DATA1 is the same as the polarity of the input image data DATA and the second polarity of the second image data DATA2 is opposite to the polarity of the input image data DATA.

The polarity inverting part 221 alternately outputs the first image data DATA1 and the second image data DATA2 every reference time, e.g., the first reference time or the second reference time.

The image data skipping part 222 skips the first frame of the second image data DATA2 when the second image data DATA2 is outputted after, e.g., immediately after, the first image data DATA1 is outputted based on the inversion signal INV1 provided from the timing control part 210. In an exemplary embodiment, the image data skipping part 222 determines weather the inversion signal INV1 is in the second period, which is longer than the first period, and outputs an image skip signal DS for skipping the first frame of the second image data DATA2 to the polarity inverting part 221. In such an embodiment, the first frame of the second image data DATA2 is not outputted to the data line DL, when the second image data DATA2 is outputted after, e.g., immediately after, the first image data DATA1 is outputted.

In an exemplary embodiment, the image data skipping part 222 skips the first frame of the first image data DATA1 when the first image data DATA1 is outputted after, e.g., immediately after, the second image data DATA2 is outputted based on the inversion signal INV1 provided from the timing control part 210. In such an embodiment, the first frame of the first image data DATA1 is not outputted to the data line DL, when the first image data DATA1 is outputted after, e.g., immediately after, the second image data DATA2 is outputted.

FIG. 4 is a signal timing diagram illustrating an exemplary embodiment of the first image data DATA1 and the second image data DATA2 outputted from the data driving part 220 according to the inversion signal INV1 of FIG. 1.

Referring to FIGS. 1 to 4, the input image data DATA may include a first grayscale data CDATA1 having a first level corresponding to a first grayscale value, a second grayscale data CDATA2 having a second level less than the first level and corresponding to a second grayscale value less than the first grayscale value, and a third grayscale data CDATA3 having a third level greater than the first level and corresponding to a third grayscale value greater than the first grayscale value.

In one exemplary embodiment, for example, the first grayscale value may correspond to a gray color, the second grayscale value may correspond to a black color and the third grayscale value may correspond to a white color. In such an embodiment, a value of the first level of the first grayscale data CDATA1 may be about 2, a value of the second level of the second grayscale data CDATA2 may be about 1, and a value of the third level of the third grayscale data CDATA3 may be about 3.

The inversion signal INV1 is inverted every first period T1, and the first period T1 may correspond to the period of the frame. In one exemplary embodiment, for example, a frequency of the input data signal DATA may be about 60 hertz (Hz). In such an embodiment, the first period T1 may be about 1/60 second (sec).

In an exemplary embodiment, the first grayscale data CDATA1 and the second grayscale data CDATA2 are alternately included in the image input data DATA every first period T1 with inverted polarities based on the inversion signal INV1. The second grayscale data CDATA2 and the third grayscale data CDATA3 are alternately included in the image input data DATA every first period T1 with inverted polarities based on the inversion signal INV1.

The inversion signal INV1 may maintain the level thereof without being inverted during the second period T2, which may be twice longer than the first period T1 and occurs every reference time, e.g., the first reference time or the second reference time. The first reference time may correspond to N frames and the second reference time may correspond to M frames. In one exemplary embodiment, for example, each of N and M is 6.

The data driving part 220 alternately outputs the first image data DATA1 and the second image data DATA2 every reference time, e.g., the first reference time or the second reference time, at the second period T2. In one exemplary embodiment, for example, the data driving part 220 may output the first image data DATA1 during the first reference time at the second period T2, and output the second image data DATA2 during the second reference time at the second period T2.

The polarity of the first image data DATA1 and the polarity of the second image data DATA2 are opposite to each other. In one exemplary embodiment, for example, when the first image data DATA1 has a positive (+) value correspondingly to the black color, the second image data DATA2 may have a negative (−) value correspondingly to the black color.

The data driving part 220 skips the first frame of the second image data DATA2 when the data driving part 220 outputs the second image data DATA2 after, e.g., immediately after, the data driving part 220 outputs the first image data DATA1. In addition, the data driving part 220 skips the first frame of the first image data DATA1 when the data driving part 220 outputs the first image data DATA1 after, e.g., immediately after, the data driving part 220 outputs the second image data DATA2.

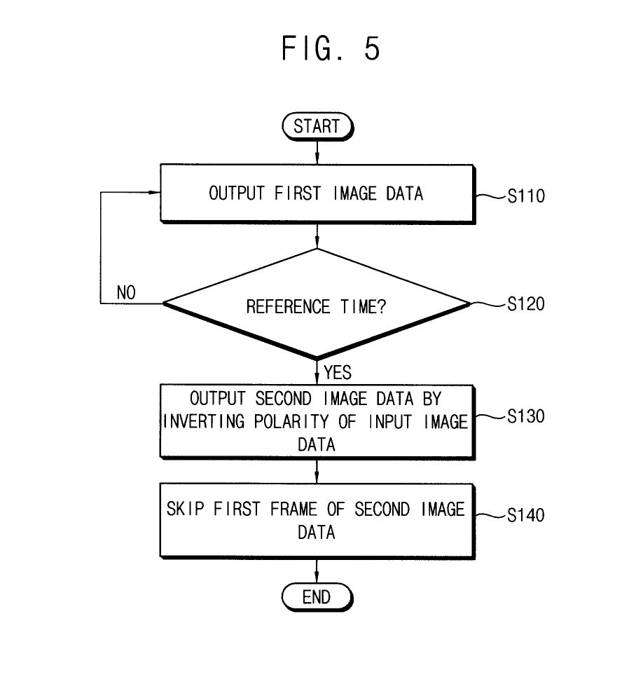

FIG. 5 is a flow chart illustrating an exemplary embodiment of a method of driving a display panel performed by the driving apparatus 200 of FIG. 1.

Referring to FIGS. 1 to 5, the data driving part 220 outputs the first image data DATA1 to a data line (step S110). In an exemplary embodiment, the data driving part 220 does not invert the polarity of the input image data DATA provided from the timing control part 210 and outputs the first image data DATA1 based on the input image data DATA such that the first polarity of the first image data DATA1 is the same as the polarity of the input image data DATA.

The timing control part 210 determines whether the first reference time is reached (step S120). In such an embodiment, the data driving part 220 outputs the first image data DATA1 until the first reference time is reached. The first reference time may be measured by the timer 217 in the timing control part 210.

When the first reference time is reached, the data driving part 220 outputs the second image data DATA2 having the second polarity inverted from the polarity of the input image data DATA to the data line (step S130). In an exemplary embodiment, the data driving part 220 may output the second image data DATA2 by inverting the polarity of the input image data DATA outputted from the timing control part 210 based on the inversion signal INV1 such that the second polarity of the second image data DATA2 is opposite to the polarity of the input image data DATA.

The inversion signal INV1 is inverted every first period T1, the inversion signal INV1 maintains the level thereof without being inverted during the second period T2, which is twice longer than the first period T1, and the second image data DATA2 is outputted to the data line at a central portion of the second period T2.

The data driving part 220 skips the first frame of the second image data DATA2 (step S140). In an exemplary embodiment, the data driving part 220 does not output the first frame of the second image data DATA2 to the data line DL, when the data driving part 220 outputs the second image data DATA2 after, e.g., immediately after, the data driving part 220 outputs the first image data DATA1.

In an exemplary embodiment, the data driving part 220 outputs the first image data DATA1 having the first polarity opposite to the second polarity of the second image data DATA2, when the second reference time is reached after the data driving part 220 outputs the second image data DATA2.

In an exemplary embodiment, the data driving part 220 skips the first frame of the first image data DATA1. In such an embodiment, the data driving part 220 does not output the first frame of the first image data DATA1 to the data line DL, when the data driving part 220 outputs the first image data DATA1 after, e.g., immediately after, the data driving part 220 outputs the second image data DATA2.

According to an exemplary embodiment, the timing control part 210 measures the first reference time and the second reference time, the first image data DATA1 and the second image data DATA2 having the second polarity opposite to the first polarity of the first image data DATA1 are alternately outputted to the data line DL during the first reference time and the second reference time, respectively, and thus a direct current afterimage displayed on the display panel 110 is effectively prevented.

In an exemplary embodiment, the first frame of the first image data DATA1 and the first frame of the second image data DATA2 are not outputted to the data line DL when the first image data DATA1 and the second image data DATA2 are outputted from the data driving part 220, and thus a flicker on the display panel 110 is effectively prevented.

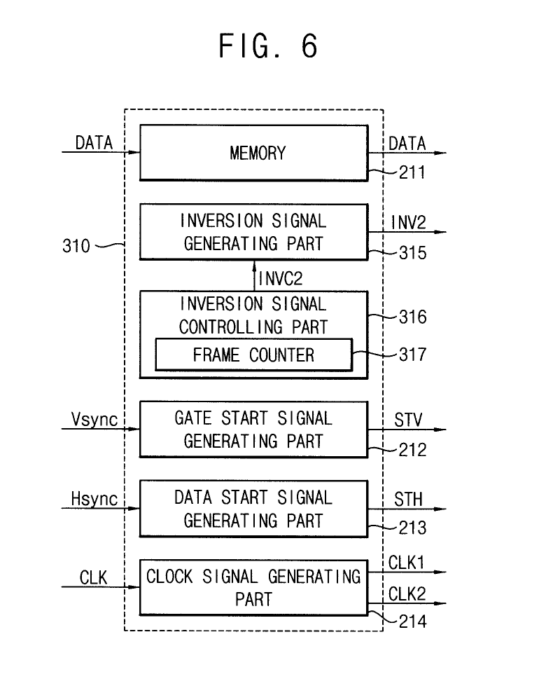

FIG. 6 is a block diagram illustrating an alternative exemplary embodiment of a timing control part according to the invention.

An exemplary embodiment of the timing control part 310 may be disposed in the driving apparatus 200, as illustrated in FIG. 1, and the timing control part 310 shown in FIG. 6 is substantially the same as the timing control part 210 shown in FIG. 2 except for an inversion signal generating part 315 and an inversion signal controlling part 316. Thus, the same reference characters will be used to refer to same or like elements as those in the example embodiment of the timing control part 201 in FIG. 2, and any repetitive detailed description thereof will be omitted.

Referring to FIG. 6, the timing control part 310 includes the memory 211, the gate start signal generating part 212, the data start signal generating part 213, the clock signal generating part 214, the inversion signal generating part 315 and the inversion signal controlling part 316.

The inversion signal generating part 315 generates an inversion signal INV2 and outputs the inversion signal INV2 to the data driving part 220. The inversion signal INV2 may be inverted every first period, and the first period may correspond to the period of the frame.

The inversion signal controlling part 316 outputs an inversion signal controlling signal INVC2 to the inversion signal generating part 315 to control the inversion signal INV2. In one exemplary embodiment, for example, the inversion signal controlling part 316 may control the inversion signal INV2 to maintain the level thereof without being inverted during the second period, which is twice longer than the first period and occurs every reference time, e.g., the first reference time or the second reference time. The inversion signal controlling part 316 may have a frame counter 317 which counts the frame to measure the first reference time or the second reference time.

In one exemplary embodiment, for example, each of the first reference time and the second reference time may be about 15 seconds, the frequency of the vertical synchronous signal Vsync may be about 60 Hz, and the inversion signal controlling part 316 outputs the inversion signal controlling signal INVC2 to the inversion signal generating part 315 such that the inversion signal INV2 maintains the level thereof during the second period when the frame counter 317 counts about 900 numbers of the frames.

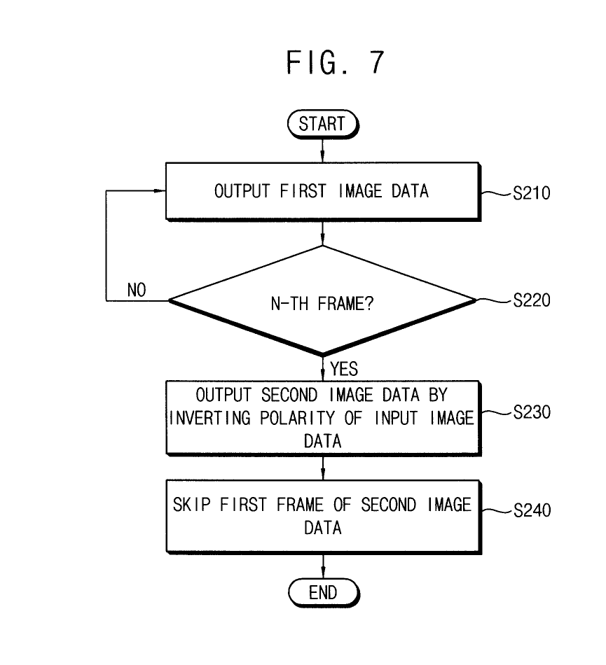

FIG. 7 is a flow chart illustrating an exemplary embodiment of a method of driving a display panel performed by a driving apparatus including the timing control part 310 of FIG. 6 and the data driving part 220 of FIG. 3.

Referring to FIGS. 1, 3 and 6, the data driving part 220 outputs the first image data DATA1 to a data line (step S210). In an exemplary embodiment, the data driving part 220 does not invert the polarity of the input image data DATA provided from the timing control part 310 and output the first image data DATA1 based on the input image data DATA. Thus, the first polarity of the first image data DATA1 is the same as the polarity of the input image data DATA.

The timing control part 310 determines that an N-th frame is reached (step S220). At the beginning of the N-th frame, which corresponds to the first reference time, the second period occurs, and the inversion signal INV2 maintains the level thereof without being inverted during the second period. The data driving part 220 outputs the first image data DATA1 until the N-th frame is reached. The N-th frame may be counted by the frame counter 317 in the timing control part 310.

When the N-th frame is reached, the data driving part 220 outputs the second image data DATA2 having the second polarity inverted from the polarity of the input image data DATA to the data line (step S230). In an exemplary embodiment, the data driving part 220 may output the second image data DATA2 by inverting the polarity of the input image data DATA outputted from the timing control part 310 based on the inversion signal INV2. Thus, the second polarity of the second image data DATA2 is opposite to the polarity of the input image data DATA.

The data driving part 220 skips the first frame of the second image data DATA2 (step S240). In an exemplary embodiment, the data driving part 220 does not output the first frame of the second image data DATA2 to the data line DL, when the data driving part 220 outputs the second image data DATA2 after, immediately after, the data driving part 220 outputs the first image data DATA1.

In an exemplary embodiment, the data driving part 220 outputs the first image data DATA1 having the first polarity opposite to the second polarity of the second image data DATA2, when the N-th frame is counted after the data driving part 220 outputs the second image data DATA2.

In an exemplary embodiment, the data driving part 220 skips the first frame of the first image data DATA1. In such an embodiment, the data driving part 220 does not output the first frame of the first image data DATA1 to the data line, when the data driving part 220 outputs the first image data DATA1 after the data driving part 220 outputs the second image data DATA2.

According to an example embodiment, the timing control part 310 counts the frame, the first image data DATA1 and the second image data DATA2 having the second polarity opposite to the first polarity of the first image data DATA1 are alternately outputted to the data line DL, and thus a direct current afterimage displayed on the display panel 110 is effectively prevented.

In an exemplary embodiment, the first frame of the first image data DATA1 and the first frame of the second image data DATA2 are not outputted to the data line DL when the first image data DATA1 and the second image data DATA2 are outputted from the data driving part 220, and thus a flicker on the display panel 110 is effectively prevented.

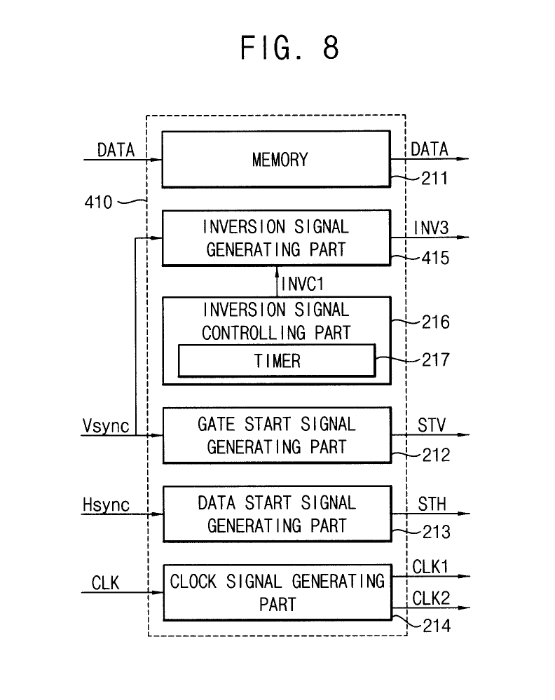

FIG. 8 is a block diagram illustrating another alternative exemplary embodiment of a timing control part according to the invention.

In an exemplary embodiment, the timing control part 410 may be in the driving apparatus 200 illustrated in FIG. 1, and the timing control part 410 shown in FIG. 8 is substantially the same as the timing control part 210 shown in in FIG. 2 except for an inversion signal generating part 415. Thus, the same reference characters will be used to refer to same or like elements as those in the example embodiment of FIG. 2, and any repetitive detailed description thereof will be omitted.

Referring to FIG. 8, the timing control part 410 includes the memory 211, the gate start signal generating part 212, the data start signal generating part 213, the clock signal generating part 214, the inversion signal generating part 415 and the inversion signal controlling part 216.

The inversion signal generating part 415 receives the vertical synchronous signal Vsync, generates an inversion signal INV3 using the vertical synchronous signal Vsync and outputs the inversion signal INV3 to the data driving part 220. The inversion signal INV3 may be inverted every first period, and the first period may be determines by the vertical synchronous signal Vsync.

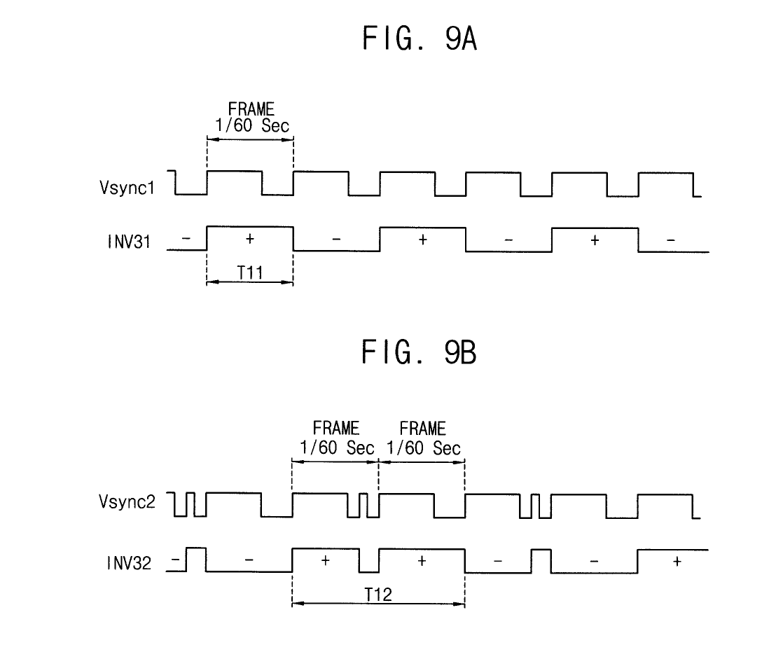

FIG. 9A is a waveform diagram illustrating an exemplary embodiment of a vertical synchronous signal Vsync1 applied to the inversion signal generating part 415 of FIG. 8 and an inversion signal INV31 outputted from the inversion signal generating part 415 of FIG. 8.

Referring to FIG. 9A, the inversion signal INV31 is inverted based on the vertical synchronous signal Vsync1. In an exemplary embodiment, the inversion signal INV31 alternately has a low level and a high level at a rising edge of the vertical synchronous signal Vsync1. Thus, the inversion signal INV31 is toggled at the rising edge of the vertical synchronous signal Vsync1.

In such an embodiment, the inversion signal INV31 is inverted every first period T11, and the first period T11 may correspond to the period of the frame. In one exemplary embodiment, for example, the first period T11 may be about 1/60 second when a frequency of the vertical synchronous signal Vsync1 is about 60 Hz.

FIG. 9B is a waveform diagram illustrating an alternative exemplary embodiment of a vertical synchronous signal Vsync2 applied to the inversion signal generating part 415 of FIG. 8 and an inversion signal INV32 outputted from the inversion signal generating part 415 of FIG. 8.

Referring to FIG. 9B, the inversion signal INV32 is inverted based on the vertical synchronous signal Vsync2. In an exemplary embodiment, the inversion signal INV32 alternately has a low level and a high level at a rising edge of the vertical synchronous signal Vsync2. Thus, the inversion signal INV32 is toggled at the rising edge of the vertical synchronous signal Vsync2.

In such an embodiment, the inversion signal INV32 is inverted every first period T12, and the first period T12 may correspond to a period of two frames. In one exemplary embodiment, for example, the first period T12 may be about 1/30 second when the frequency of the vertical synchronous signal Vsync2 is about 60 Hz.

A time of the low level between the high levels is substantially short in the first period T12 of the inversion signal INV32, and thus the low level between the high levels in the first period T12 of the inversion signal INV32 may not influence the polarity of the input image data DATA

A method of driving a display panel performed by a driving apparatus including the timing control part 410 of FIG. 8 and the data driving part 220 of FIG. 3 is substantially the same as the method described with reference to FIG. 5.

According to the exemplary embodiment, the inversion signal INV3 is generated based on the vertical synchronous signal Vsync, the first image data DATA1 and the second image data DATA2 having the second polarity opposite to the first polarity of the first image data DATA1 are alternately outputted to the data line, and thus a direct current afterimage displayed on the display panel 110 is effectively prevented.

In an exemplary embodiment, the first frame of the first image data DATA1 and the first frame of the second image data DATA2 are not outputted to the data line DL when the first image data DATA1 and the second image data DATA2 are outputted from the data driving part 220, and thus a flicker on the display panel 110 is effectively prevented.

According to an exemplary embodiment of the method of driving the display panel, the driving apparatus for performing the method and the display apparatus including the driving apparatus, a first image data and a second image data having a polarity opposite to a polarity of the first image data are alternately outputted to a data line, and thus a direct current afterimage displayed on a display panel is effectively prevented.

In an exemplary embodiment of the method of driving the display panel, a first frame of the first image data and a first frame of the second image data are not outputted to the data line when the first image data and the second image data are outputted from a data driving part, and thus a flicker on the display panel is effectively prevented, and display quality of the display apparatus is thereby substantially improved.

The foregoing is illustrative of the invention and is not to be construed as limiting thereof. Although a few exemplary embodiments of the invention have been described, those skilled in the art will readily appreciate that many modifications are possible in the exemplary embodiments without materially departing from the novel teachings of the invention. Accordingly, all such modifications are intended to be included within the scope of the invention as defined in the claims. In the claims, means-plus-function clauses are intended to cover the structures described herein as performing the recited function and not only structural equivalents but also equivalent structures. Therefore, it is to be understood that the foregoing is illustrative of the invention and is not to be construed as limited to the specific exemplary embodiments disclosed, and that modifications to the disclosed exemplary embodiments, as well as other exemplary embodiments, are intended to be included within the scope of the appended claims. The invention is defined by the following claims, with equivalents of the claims to be included therein.

What is claimed is:

1. A method of driving a display panel, the method comprising:
receiving an input image data, based on which the display panel displays an image;
outputting a first image data during N frames corresponding to a first reference time and outputting a second image data during M frames corresponding to a second reference time, based on a inversion signal, wherein N and M are natural numbers, the first image data has a first polarity equal to a polarity of the input image data, and the second image data has a second polarity inverted from the polarity of the input image data; and
skipping a first frame of the first image data and a first frame of the second image data based on the inversion signal.

2. The method of claim 1, wherein
the inversion signal is inverted every first period, and
the skipping the first frame of the first image data and the first frame of the second image data comprises determining a second period, which is longer than the first period.

3. The method of claim 2, further comprising:
measuring the first reference time and the second reference time to alternately output the first image data and the second image data.

4. The method of claim 3, wherein the measuring the first reference time and the second reference time comprises counting the number of frames.

5. The method of claim 2, wherein the second period is twice longer than the first period.

6. The method of claim 1, wherein
the image data comprises:
a first grayscale data having a first level corresponding to a first grayscale; and
a second grayscale data having a second level less than the first level and corresponding to a second grayscale less than the first grayscale,
the inversion signal is inverted every first period, and
the first grayscale data and the second grayscale data are alternately disposed every first period in the image data with inverted polarities based on the inversion signal.

7. The method of claim 1, wherein
the image data comprises:
a first grayscale data having a first level corresponding to a first grayscale; and
a third grayscale data having a third level greater than the first level and corresponding to a third grayscale greater than the first grayscale,
the inversion signal is inverted every first period, and
the first grayscale data and the third grayscale data are alternately disposed every first period in the image data with inverted polarities based on the inversion signal.

8. The method of claim 1, wherein the inversion signal is inverted every first period based on a vertical synchronous signal.

9. The method of claim 8, wherein the first period corresponds to a period of a frame.

10. The method of claim 8, wherein the first period corresponds to a period of two frames.

11. The method of claim 1, wherein the image data corresponds to a scanning method, which is converted from an interlaced scanning method to a sequential scanning method.

12. A driving apparatus comprising:
a timing control part which generates an inversion signal which inverts a polarity of an input image data applied to a display panel; and
a data driving part which outputs a first image data during N frames corresponding to a first reference time and a second image data during M frames corresponding to a second reference time based on the inversion signal, and skips a first frame of the first image data and a first frame of the second image data,
wherein N and M are natural numbers,
the first image data has a first polarity equal to the polarity of the input image data, and
the second image data has a second polarity inverted from the polarity of the input image data.

13. The driving apparatus of claim 12, wherein
the inversion signal is inverted every first period, and
the data driving part determines a second period, which is longer than the first period.

14. The driving apparatus of claim 13, wherein the timing control part comprises a timer which measures the first reference time and the second reference time.

15. The driving apparatus of claim 13, wherein the timing control part comprises a frame counter which counts the number of frames to measure the first reference time and the second reference time.

16. The driving apparatus of claim 13, wherein the second period is twice longer than the first period.

17. The driving apparatus of claim 12, wherein the image data corresponds to a scanning method, which is converted from an interlaced scanning method to a sequential scanning method.

18. A display apparatus comprising:
a display panel which displays an image based on an input image data; and
a driving apparatus comprising:
a timing control part which generates an inversion signal inverting a polarity of the input image data applied to the display panel; and
a data driving part which outputs a first image data during N frames corresponding to a first reference time and a second image data during M frames corresponding to a second reference time based on the inversion signal and skips a first frame of the first image data and a first frame of the second image data,
wherein N and M are natural numbers,
the first image data has a first polarity equal to the polarity of the input image data, and
the second image data has a second polarity inverted from the polarity of the input image data.

19. The display apparatus of claim 18, wherein
the inversion signal is inverted every first period, and
the data driving part determines a second period longer than the first period.

20. The display apparatus of claim 19, wherein the second period is twice longer than the first period.
